(19) United States
(12) Patent Application Publication
(10) Pub. No.: US 2003/0236997 A1
(43) Pub. Date: Dec. 25, 2003

(54) Secure network agent

(76) Inventor: Paul Jacobson, Brookline, MA (US)

Correspondence Address: FISH & RICHARDSON PC, 225 FRANKLIN ST, BOSTON, MA, 02110, US

(21) Appl. No.: 10/179,532

(22) Filed: Jun. 24, 2002

(51) Int. Cl. H04L 9/00; G06F 15/173

(52) U.S. Cl. 713/200; 713/201; 709/238

(57) ABSTRACT

A secure network agent is provided. The method includes redirecting an insecure network application in a client system to a secure gateway configured to communicate with systems residing in remote network.

### TECHNICAL FIELD

The present invention relates to a secure network agent.

### BACKGROUND

The Internet supports a vast and growing community of computers and computer users around the world. Unfortunately, the Internet can provide anonymous access to private networks by the unscrupulous, careless, or dangerous. To protect private networks from security violations, such as outside attacks and capture of sensitive information, network designers deal with a tradeoff between security and convenience. Most designers opt for convenience and use a simple router between their internal networks and the Internet.

A gateway is a network point that acts as an entrance to another network. On the Internet, a node or stopping point can be either a gateway node or a host (end-point) node. Both the computers of Internet users and the computers that serve pages to users are host nodes. The computers that control traffic within a company's network or at a local Internet service provider (ISP) are gateway nodes.

In an enterprise that uses the Internet, a proxy server is a server that acts as an intermediary between a workstation user and the Internet so that the enterprise can ensure security, administrative control, and caching service. A proxy server is associated with or part of a gateway server that separates the enterprise network from the outside network and a firewall server that protects the enterprise network from outside intrusion.

A proxy server receives a request for an Internet service (such as a Web page request) from a user. If it passes filtering requirements, the proxy server, assuming it is also a cache server, looks in its local cache of previously downloaded Web pages. If it finds the page, it returns it to the user without needing to forward the request to the Internet. If the page is not in the cache, the proxy server, acting as a client on behalf of the user, uses one of its own IP addresses to request the page from the server out on the Internet. When the page is returned, the proxy server relates it to the original request and forwards it on to the user.

### SUMMARY

In an aspect, the invention features a method including redirecting an insecure network application in a client system to a secure gateway configured to communicate with systems residing in a remote network.

One or more of the following may be included. Redirecting may include configuring a port on the client system. Redirecting may also include configuring an Internet Protocol (IP) address of a gateway system, configuring a port number of the gateway system and passing data locally to the configured port number of the gateway system.

The insecure network application may be a Hypertext Transfer Protocol (HTTP) browser application, a Simple Network Management Protocol (SNMP) application, and a Telnet application.

In another aspect, the invention features a method including, in a network, generating a request from a insecure network application in a user system to a remote system, redirecting the request to a secure gateway configured to communicate with systems residing in the network, and sending the request from the secure gateway to the remote system.

One or more of the following may be included. The insecure network application may be a Hypertext Transfer Protocol (HTTP) browser application, a Simple Network Management Protocol (SNMP) application, and a Telnet application.

Redirecting may include configuring a port on the user system, configuring an Internet Protocol (IP) address of a gateway system, configuring a port number of the gateway system, and passing data locally to the configured port number of the gateway system.

Embodiments of the invention may have one or more or the following advantages.

The process executes on two computers and provides a secure channel between the two computers. Insecure networking applications can use the process and tunnel through, thus securing the network application.

Insecure networking applications require no modifications to the underlying application. The insecure networking applications, such as Telnet and HTTP browsers, can be utilized “as is” with the process, unlike SSL.

The process does not require IPSEC to be added to the TCP/IP stack.

The process insures security by utilizing private key cryptography and does not use public key methods that typically require extensive computational resources.

The process requires no parsing of information, e.g., parsing of IP addresses. The process utilizes security that is already in place as implemented in an existing configuration, e.g., two proxy servers connected by a secure channel, and works on most any single channel system.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a system.

FIG. 2 is a flow diagram of the secure agent process of FIG. 1.

### DETAILED DESCRIPTION

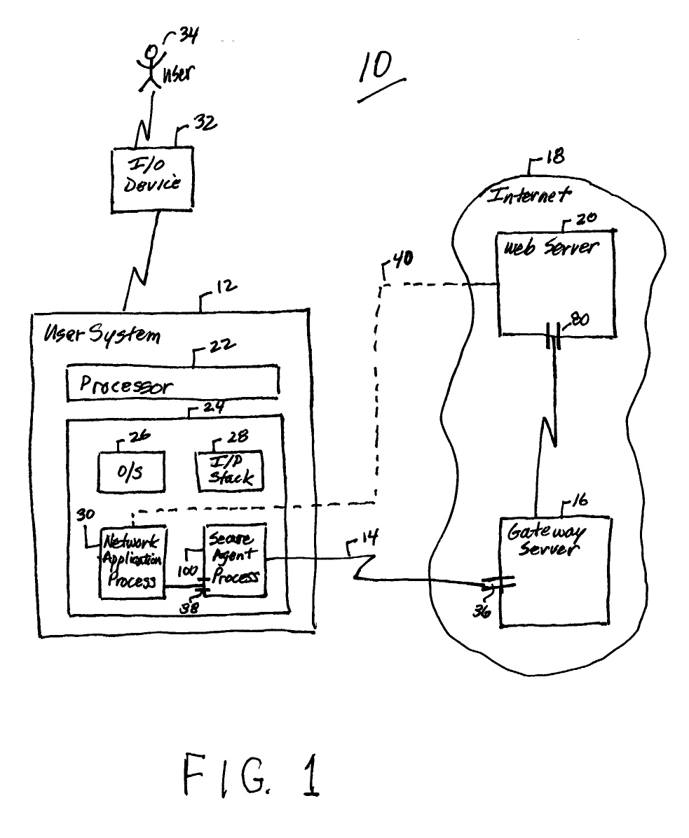

Referring to FIG. 1, a system 10 includes a user system 12 linked via a secure line 14 to a gateway server 16 residing on the Internet 18. The gateway server 16 is linked to a Web server 20 residing on the Internet 18. The user system 12 includes a processor 22, and a memory 24. Memory 24 includes an operating system (O/S) 26 such as Microsoft Windows or Linux, an I/P stack 28, a network application process 30 and a secure agent process 100. The user system 12 also includes a link to an input/output (I/O) device 32 for use by a user 34.

The network application process 30 may be any network application. Example network applications include Telnet, SNMP, and browser processes such as Netscape Navigator from AOL Inc. and Internet Explorer from Microsoft Corporation.

In examples, the secure agent process 100 may reside in a gateway server, such as a proxy server, or resident in the user system 12 as shown in FIG. 1.

System 10 is a client/server system in which user system 12 is a client system and Web server 20 is a server system. In general, client/server describes a relationship between two systems in which one system, the client, makes a service request to another system, the server, which fulfills the request. In a network, the client/server model provides a convenient way to interconnect systems that are distributed across different locations. In a typical client/server system, a Transmission Control Protocol (TCP)-based client or User Datagram Protocol (UDP)-based client contacts a passive server, then, based on the specific protocol, exchanges information. Unless the protocol includes encryption and key exchange, this information can be viewed, replayed, or even altered. Protocols like Secure Sockets Layer (SSL) and Secure Socket Shell (SSH) are standard cryptosystems, residing above the TCP/IP layer, that allow insecure protocols to tunnel through. A downside of SSL or SSH is that they require clients and servers to be altered to be used. For example, if a user wanted to run Telnet over SSL, the user would have to find a Telnet server that supports SSL, and the user would have to find a Telnet client that supports SSL. For Web-based applications, this is often not a problem, because Netscape Navigator and Internet Explorer, for example, support SSL. However, this is a problem with, for example, Telnet.

A solution to this problem is to use systems like Internet Protocol Security (IPsec), which is often used to provide a Virtual Private Network (VPN). IPsec executes below the TCP/IP layer so there is no effect at the application layer. For example, a user can execute Telnet or anything through an IPsec tunnel. However, when using IPsec, everything is encrypted, and this is problematic since encryption has a large impact on performance throughput. Moreover, IPsec is quite large and not often used on computer systems.

The secure agent process 100 overcomes these shortcomings. The secure agent process 100 is an application layer process, like SSL, which can be used and installed by users and provides a secure tunnel between two systems.

Without using secure agent process 100, the user 34 Telnets or browses (or most any client/server application) to the Web server 20 directly. Using Netscape Navigator as an example, the User 34 initiates the Navigator process 30 to contact an Internet Protocol (IP) address of the Web server 20. The Netscape Navigator process 30 goes out over an insecure Internet link 40 (shown in tandem) and connects to Web server 20, where the Web protocol always uses, for example, port 80, which is the Web server 20.

Using the same example with the secure agent process 100, the user 34 configures the secure agent process 100 to contact it's peer, i.e., gateway server 16, over the secure link 14, on a previously agreed upon server port 36, for example. The secure link 14 may be activated when the secure agent process 100 receives a client request from the network application process 30. The user 34 initiates the network application process 30 to contact the secure agent process 100 on a service port 38, for example. The secure agent process 100 communicates with gateway server 16, passing configuration information that tells the gateway server 16 that this communication should be forwarded to the gateway server's 16 Web server on port 80, which is the Web server 20. Meanwhile, all the security parameters are setup according to the configurations of the agents, i.e., secure agent process 100 and gateway server 16. Thus, when actual Web requests come from the Netscape Navigator (or any network application process 30) they are secured by the secure agent process 100 and passed on the secure link 14, then received by the peer agent gateway server 16, which then forwards the request to the Web server 20. Now, the Web server 20 processes the client's request, and the response is passed back to the Netscape Navigator via the gateway server 16, the secure link 14 and the secure agent process 100. However, the Web content looks the same on the Netscape Navigator browser, as it did if the system 10 used the insecure link 40.

Using secure agent process 100, the only data that appears on a network is the traffic on link 14. The traffic on link 14 is encrypted according to the parameters agreed upon between secure agent process 100 and gateway server 16, and thus the secure channel 14 is independent of the network application process 30.

A benefit of using secure agent process 100 is that the network application process 30 and the Web server 20 can be replaced with any other single channel TCP or UDP client/server pair. This includes, for example, Telnet, Simple Network Management Protocol (SNMP), Simple Mail Transfer Protocol (SMTP), and Post Office Protocol 3 (POP3). It also includes any proprietary client/server code, as long as it's limited to single channel (one communication link) services. All of these client/server pairs are used “as is,” without modification, requiring only that the secure agent process 100 and the gateway server 16 be configured such that they know about each other.

In another embodiment, network application processes not requiring a secure channel go directly to the service using the insecure Internet link 40.

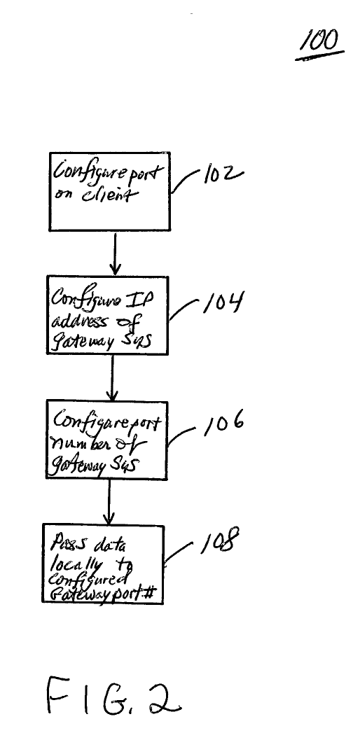

Referring to FIG. 2, the process 100 includes configuring (102) a port on a client. The process 100 configures (104) an Internet Protocol (IP) address of a gateway system. The process 100 configures (106) a port number of the gateway system and passes (108) all data locally to the configured port number of the gateway system.

Other embodiments are within the scope of the following claims.

What is claimed is:

1. A method comprising:
redirecting an insecure network application in a client system to a secure gateway configured to communicate with systems residing in a remote network.

2. The method of claim 1 in which redirecting comprises configuring a port on the client system.

3. The method of claim 2 in which redirecting further comprises configuring an Internet Protocol (IP) address of a gateway system.

4. The method of claim 3 in which redirecting further comprises configuring a port number of the gateway system.

5. The method of claim 4 in which redirecting further comprises passing data locally to the configured port number of the gateway system.

6. The method of claim 1 in which the insecure network application is a Hypertext Transfer Protocol (HTTP) browser application.

7. The method of claim 1 in which the insecure network application is a Simple Network Management Protocol (SNMP) application.

8. The method of claim 1 in which the insecure network application is a Telnet application.

9. A method comprising:
in a network, generating a request from a insecure network application in a user system to a remote system,
redirecting the request to a secure gateway configured to communicate with systems residing in the network; and
sending the request from the secure gateway to the remote system.

10. The method of claim 9 in which the insecure network application is a Hypertext Transfer Protocol (HTTP) browser application.

11. The method of claim 9 in which the insecure network application is a Simple Network Management Protocol (SNMP) application.

12. The method of claim 9 in which the insecure network application is a Telnet application.

13. The method of claim 9 in which redirecting comprises:
configuring a port on the user system;
configuring an Internet Protocol (IP) address of a gateway system;
configuring a port number of the gateway system; and
passing date locally to the configured port number of the gateway system.

14. An apparatus for handling insecure network application requests, the apparatus comprising:
a memory that stores executable instructions; and
a processor that executes the instructions to:
redirect an insecure network application in a client system to a secure gateway configured to communicate with systems residing in a remote network.

15. An article comprising a machine-readable medium, which stores executable instructions causing a machine to:
redirect an insecure network application in a client system to a secure gateway configured to communicate with systems residing in a remote network.

16. An apparatus for handling insecure network application requests, the apparatus comprising:
a memory that stores executable instructions; and
a processor that executes the instructions to:
generate a request from an insecure network application in a user system to a remote system; and
redirect the request to a secure gateway configured to communicate with systems residing in the remote network.

17. An article comprising a machine-readable medium, which stores executable instructions causing a machine to:
generate a request from an insecure network application in a user system to a remote system; and
redirect the request to a secure gateway configured to communicate with systems residing in the remote network.
